(19) United States
(12) Patent Application Publication
(10) Pub. No.: US 2007/0271751 A1
(43) Pub. Date: Nov. 29, 2007

(54) METHOD OF FORMING A RELIABLE ELECTROCHEMICAL CAPACITOR

(76) Inventor: Timothy W. WEIDMAN, Sunnyvale, CA (US)

Correspondence Address: PATTERSON & SHERIDAN, LLP, 3040 POST OAK BOULEVARD, SUITE 1500, HOUSTON, TX, 77056, US

(21) Appl. No.: 11/837,375

(22) Filed: Aug. 10, 2007

Related U.S. Application Data
(63) Continuation-in-part of application No. 11/228,649, filed on Sep. 15, 2005.
(60) Provisional application No. 60/648,004, filed on Jan. 27, 2005.

(51) Int. Cl. H01G 9/00

(52) U.S. Cl. 29/25.03

(57) ABSTRACT

The present invention generally relates to the method of creating a reliable and cost efficient electrochemical capacitor electrode that has an improved lifetime, lower production cost and improved process performance. The invention generally includes treating or conditioning an electrode surface by depositing a ruthenium containing layer, or layers, having good adhesion to the substrate, low electrical resistivity (high conductivity) and has good resistance to chemical attack during the operation of electrochemical capacitor. One aspect of the invention discussed herein is a method of forming an electrode by depositing a ruthenium containing layer at relatively low temperatures, such as <180° C.

### CROSS-REFERENCE TO RELATED APPLICATIONS

This application is a continuation-in-part of U.S. patent application Ser. No. 11/228,649 [APPM 9906.02], filed Sep. 15, 2005, which claims the benefit of U.S. Provisional Patent Application Ser. No. 60/648,004, filed Jan. 27, 2005 which is herein incorporated by reference.

### BACKGROUND OF THE INVENTION

1. Field of the Invention

Embodiments of the present invention generally relate to the method of forming an electrochemical capacitor.

2. Description of the Related Art

Electrical energy can generally be stored in two fundamentally different ways: 1) indirectly in batteries as potential energy available as chemical energy that requires oxidation and reduction of active species, or 2) directly, using electrostatic charge formed on plates of a capacitor. Typically, ordinary capacitors store a small amount of charge generally due to their size and thus only store a small amount of electrical energy. Energy storage in conventional capacitors is generally non-Faradaic, meaning that no electron transfer takes place across an electrode interface, and the storage of electric charge and energy is electrostatic.

In an effort to form an effective electrical energy storage device that can store sufficient charge to be useful as independent power sources, or supplemental power source for a broad spectrum of portable electronic equipment and electric vehicles, devices known as electrochemical capacitors have been created. Electrochemical capacitors are energy storage devices which combine some aspects of the high energy storage potential of batteries with the high energy transfer rate and high recharging capabilities of capacitors. The term electrochemical capacitor is sometimes described in the art as a super-capacitor, electrical double-layer capacitors, or ultra-capacitor. Electrochemical capacitors can have hundreds of times more energy density than conventional capacitors and thousands of times higher power density than batteries. It should be noted that energy storage in electrochemical capacitors can be both Faradaic or non-Faradaic.

In both the Faradaic and non-Faradaic electrochemical capacitors, capacitance is highly dependent on the characteristics of the electrode and electrode material. Ideally, the electrode material should be electrically conducting and have a large surface area. Typically, the electrode material will be formed from porous structures to enable the formation of a large surface area that can be used either for the development of the electrical double layer for static charge storage to provide non-Faradaic capacitance or for the reversible chemical redox reaction sites to provide Faradaic capacitance.

Examples of electrochemical capacitors that are of the Faradaic type include redox electrochemical capacitors based on mixed metal oxides, such as ruthenium dioxide (RuO₂) and other transition metal oxides. Electrochemical capacitors that utilize ruthenium dioxide (RuO₂) have been found to deliver a high energy density and power density. Conventional methods of forming electrochemical capacitor electrodes that have a RuO₂ surface, have traditionally been done by oxidation of a physical vapor deposited (PVD) film, electrochemical plating methods in a sulfuric acid medium, or painting an anodically stable metal, such as titanium, with chlororuthenate (RuCl₃) or other Ru containing materials and then firing the painted surface in the presence of oxygen. Due to the inherent short comings of these deposition processes, such as limitations of line of sight type deposition of a ruthenium film, uniformity issues of the deposited film, and film property variability, these techniques typically struggle to form a reliable electrodes that have repeatable results. The conventional ruthenium dioxide electrochemical capacitors formed by these techniques can yield varying process results, require a significant amount of the often expensive ruthenium metal to form an electrically conductive surface, and require multiple processing steps to create the electrode surface.

To make electrochemical capacitors more of a viable product it is important to reduce the costs to produce the electrochemical capacitors, and improve the efficiency of the formed electrochemical capacitor device. Thus, there is a need for method and apparatus for forming the conductive electrochemical electrode that have an improved lifetime, improved deposited film properties, and reduced production cost.

### SUMMARY OF THE INVENTION

Embodiments of the invention generally provide a method of forming an electrochemical capacitor, comprising: providing a first substrate that has a surface that is adapted to form a portion of an electrode in an electrochemical capacitor, and depositing a ruthenium dioxide coating on the surface of the first substrate, wherein the ruthenium dioxide coating is deposited using ruthenium tetroxide.

Embodiments of the invention further provide a method of forming an electrochemical capacitor, comprising positioning a substrate that has a surface that is adapted to form a portion of a porous electrode in an electrochemical capacitor in a processing region of a processing chamber, forming a gas comprising ruthenium tetroxide in a first vessel, transferring an amount of the gas to the surface of the substrate to form a ruthenium containing layer thereon.

Embodiments of the invention further provide a method of forming an electrochemical capacitor, comprising positioning a substrate that has a surface that is adapted to form a portion of a porous electrode in an electrochemical capacitor in a processing region of a processing chamber, forming a process gas comprising ruthenium tetroxide in a first vessel, transferring at least a portion of the process gas from the first vessel to a second vessel, removing unwanted contaminants contained in the second vessel, and delivering an the ruthenium tetroxide from the second vessel to the substrate positioned on a substrate support in the processing region to form a ruthenium containing layer on a surface of the substrate.

Embodiments of the invention further provide a method of forming an electrochemical capacitor, comprising providing a substrate that has a surface that is adapted to form a portion of a porous electrode in an electrochemical capacitor, providing an aqueous solution that comprises a ruthenium metal, water and a hypochlorite containing material, adding an amount of an acid to the aqueous solution, separating the ruthenium tetroxide from the aqueous solution, and delivering the ruthenium tetroxide to the substrate positioned on a substrate support in a processing chamber.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a simplified schematic view of an active region of a electrochemical capacitors;

FIG. 2 illustrates a cross-sectional view of a deposition chamber that may be adapted to perform an embodiment described herein;

FIG. 3 illustrates a process sequence according to one embodiment described herein;

FIG. 4 illustrates a process sequence according to one embodiment described herein.

### DETAILED DESCRIPTION

The present invention generally relates to the method of creating a reliable and cost efficient electrochemical capacitor electrode that has an improved lifetime, lower production cost and improved process performance. The invention generally includes treating or conditioning an electrode surface by depositing a ruthenium containing layer, or layers, having good adhesion to the substrate, low electrical resistivity (high conductivity) and has good resistance to chemical attack during the operation of electrochemical capacitor. One aspect of the invention discussed herein is a method of forming an electrode by depositing a ruthenium containing layer at relatively low temperatures, such as <180° C. Electrodes can be of any shape (e.g., circular, square, rectangle, polygonal, etc.) and size. Also, the type of electrode material is not limiting and can be made of any material that is conductive or that can be made conductive, such as a metal, plastic, graphite, polymers, carbon-containing polymer, composite, or other suitable materials. In one embodiment, it is desirable to form an electrode out of a light weight and inexpensive plastic material, such as polyethylene, polypropylene or other suitable plastic or polymeric material, by exposing the material to ruthenium tetroxide, which can oxidize virtually any hydrocarbon material, to form an electrode that has a ruthenium containing conductive surface.

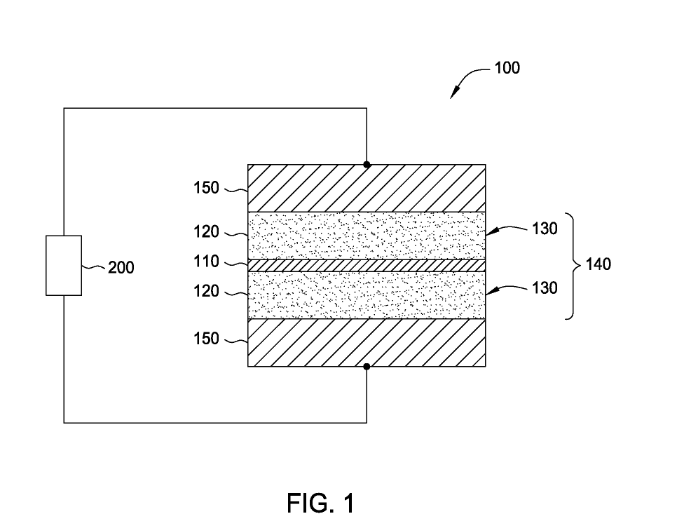

FIG. 1 illustrates a simplified schematic view of an active region 140 of an electrochemical capacitor unit 100 that can be powered by use of a power source 200. The active region 140 generally contains a membrane 110, porous electrodes 120, charge collector plates 150 and an electrolyte 130 that is in contact with the porous electrodes 120, charge collector plates 150 and membrane 110. The electrically conductive charge collector plates 150 sandwich the porous electrodes 120 and membrane 110.

The electrolyte 130 that is contained between the charge collector plates 150 generally provides a charge reservoir for the electrochemical capacitor unit 100. The electrolyte can be a solid or a fluid material that has a desirable electrical resistance and properties to achieve desirable charge or discharge properties of the formed device. If the electrolyte is a fluid, the electrolyte enters the pores of the electrode material and provides the ionic charge carriers for charge storage. A fluid electrolyte requires that a membrane 110 be non-conducting to prevent shorting of the charge collected on either of the charge collector plates 150. The membrane 110 is typically permeable to allow ion flow between the electrodes and is fluid permeable. Examples of non-conducting permeable separator material are porous hydrophilic polyethylene, fiberglass mats, and porous glass paper. The membrane 110 can be made from an ion exchange resin material, polymeric material, or a porous inorganic support. For example, an ionic perfluoronated sulfonic acid polymer membrane, such as Nafion™, available from the E.I. DuPont de Nemeours & Co. Other suitable membrane materials include Gore Select™, sulphonated fluorocarbon polymers, the polybenzimidazole (PBI) membrane (available from Celanese Chemicals, Dallas, Tex.), polyether ether ketone (PEEK) membranes and other materials.

The porous electrodes 120 generally contain a conductive material that has a large surface area and has a desirable pore distribution to allow the electrolyte to permeate the structure. The porous electrodes 120 generally need a large surface area to provide an area to form a double-layer and/or an area to allow a reaction between the solid porous electrode material and the electrolyte components (e.g., psedo-capacitance type capacitors). The porous electrodes 120 can be formed from various carbon containing materials (e.g., carbon nano-tubes, aerogels, carbon cloth), metals (e.g., titanium), plastics (e.g., polyethylene, polypropylene), glass materials (e.g., silicas), graphites, or other suitable materials.

Most successful electrochemical capacitors utilize the pseudo-capacitance type mechanism to create and store charge in the capacitor. Typically, these types of electrochemical capacitors contains mixed metal oxides, such as ruthenium, tantalum, iridium and molybdenum that are disposed on the surface of the porous electrodes 120 and/or charge collector plates 150. The most successful of these is the ruthenium metal oxide electrochemical capacitor. In this configuration a ruthenium containing layer is in contact with the electrolyte 130 and provide a reactive surface at which the adsorption of ions from the electrolyte and/or redox reactions involving ions in the electrolyte occur. In one embodiment, the ruthenium coating acts as an electrically conducting layer, an electrical contact element, and/or a layer that protects the charge collector plates 150.

Embodiments of the invention, described herein, generally contain various methods to reliably form a ruthenium containing layer on a surface of the porous electrodes 120 and/or charge collector plates 150. Since the cost of ruthenium is generally high it is desirable to minimize the volume of ruthenium used to form the electrochemical capacitor structure, while assuring that adequate surface area and coverage is provided over the porous electrodes 120 and/or charge collector plates 150. To make a cost effective electrochemical capacitor it is important to form a low cost electrochemical capacitor that will reliably work in a highly aggressive environment, such as exposure to acidic electrolytes (e.g., sulfuric acid (H₂SO₄)), or basic electrolytes (e.g., potassium hydroxide (KOH)). A ruthenium containing coating that completely covers and protects the surface of the porous electrodes 120 and/or charge collector plates 150, and that is inexpensive to deposit is thus required. It should be noted that the phrase “inexpensive to deposit” as used herein is meant to generally describe both the coating's material cost and the cost to perform the deposition process.

In general a conformal coating is needed to be formed over the surface of the porous electrodes 120 and/or charge collector plates 150 to provide a large metal oxide surface area to collect the desired amount of charge. It should be noted that the ruthenium coating when used as part of the porous electrodes 120 and/or charge collector plates 150 needs to adhere to the surface of these components, have a low electrical resistivity (i.e., high conductivity), have good resistance to chemical attack, and be relatively inexpensive to deposit.

In one embodiment, the coating contains a ruthenium (Ru) containing layer that is conformally coated over the surface of the substrate. The ruthenium (Ru) containing layer can be between about a monolayer thick (e.g., 2-3 angstrom (Å)) and about 500 angstrom (Å). Along with ruthenium dioxide's pseudo-capacitance properties that are useful in forming an electrochemical capacitor, ruthenium dioxide is also useful as a protective coating, since it can be inexpensively deposited (discussed below), and in general ruthenium containing films have a good electrical conductivity and hardness. Also, the methods described herein will allow ruthenium dioxide to be deposited at low temperatures (e.g., 20-180° C.), which makes the use of other more inexpensive electrode base materials possible, since conventional CVD ruthenium deposition processes or sintered ruthenium containing paste deposition processes require a high temperature processing steps (e.g., >250° C.) to form a comparable ruthenium dioxide layer.

Ruthenium Containing Layer Formation Process and Deposition Apparatus

As noted above two key aspects in creating a production worthy electrochemical capacitor is developing an electrochemical capacitor fabrication process that minimizes the cost to produce the device and a process that forms a device that has a desirable lifetime/reliability. As discussed above, one way to meet these goals is to inexpensively form a ruthenium containing layer that covers the surface of the porous electrodes 120 and/or charge collector plates 150. One such method described herein is adapted to selectively or non-selectively deposit a ruthenium containing layer on a surface of a porous electrodes 120 and/or charge collector plates 150 by use of a ruthenium tetroxide containing gas. The ruthenium containing layer may be deposited on the porous electrode 120 and charge collector plate 150, separately or after the two components have been placed in intimate contact. One will note that the term “substrate,” as used below, is meant to describe the porous electrode 120, charge collector plate 150 or the combination of the both porous electrode 120 and charge collector plate 150 at the same time.

It is believed that the selective or non-selective deposition of a ruthenium containing layer on the surface of the substrate is strongly dependent on the temperature and type of surfaces that are exposed to the ruthenium tetroxide containing gas. It is also believed that by controlling the temperature below, for example about 180° C., a ruthenium layer can selectively deposit on certain types of surfaces. It is believed that such deposition processes form a non-crystalline ruthenium dioxide (RuO₂) containing layer that is advantageous for use in forming a production worthy electrochemical capacitor. At higher temperatures, for example greater than 180° C., the ruthenium deposition process from a ruthenium tetroxide containing gas becomes much less selective and thus will allow a blanket film to deposit on all types of surfaces.

In one aspect, the properties of the ruthenium containing layer deposited on the surface of the substrate is specially tailored to provide a layer over the surface of the substrate. Typical desirable properties may include the formation of crystalline or amorphous metallic ruthenium layers on the surface of the substrate. Another desirable feature of using a ruthenium tetroxide deposition process is the ability to form a ruthenium dioxide layer (RuO₂) on the surface of the substrate. In this configuration ruthenium tetroxide is delivered to a processing chamber that has a substrate disposed therein to coat one or more surfaces of the substrate.

An example of various inexpensive methods of forming ruthenium tetraoxide to be used to deposit a layer on a substrate surface is further described in the commonly owned U.S. patent application Ser. No. 11/228,425[APPM 9906], filed Sep. 15, 2005, which is herein incorporated by reference in its entirety. An example of an apparatus and method of depositing a desirable ruthenium containing layer, or composite layers, is further described in the commonly owned U.S. patent application Ser. No. 11/734,913[Docket No. APPM 11086], filed Apr. 13, 2007, which is herein incorporated by reference in its entirety. An example of one method used to form ruthenium tetraoxide and deposit a ruthenium containing layer is discussed below. An exemplary apparatus and method of forming a ruthenium tetroxide containing gas to form a ruthenium containing layer on a surface of a substrate is described herein.

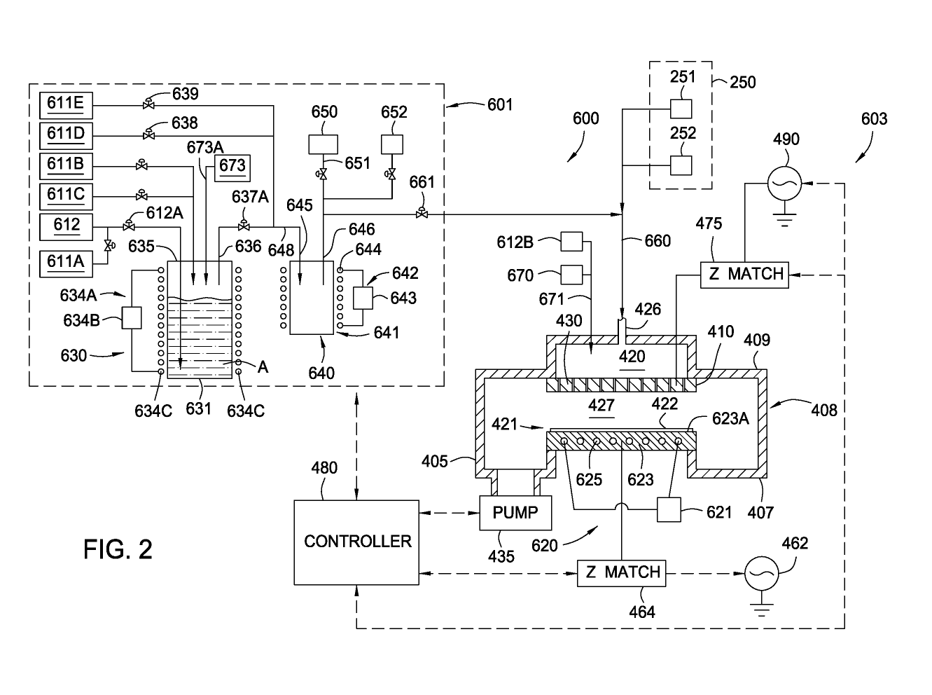

FIG. 2 illustrates one embodiment of a deposition chamber 600 that can be adapted to generate and deposit a ruthenium containing layer on a surface of a substrate. In one embodiment, the ruthenium containing layer is formed on a surface of a substrate by creating ruthenium tetroxide in an external vessel and then delivering the generated ruthenium tetroxide gas to a surface of a temperature controlled substrate positioned in a processing chamber.

In one embodiment, a ruthenium tetroxide containing gas is generated, or formed, by passing an ozone containing gas across a ruthenium source that is housed in an external vessel. In one aspect, the ruthenium source is maintained at a temperature near room temperature. In one aspect, the ruthenium source contains an amount of ruthenium metal (Ru) which reacts with the ozone. In one aspect, the metallic ruthenium source contained in the external vessel is in a powder, a porous block, or solid block form.

In another aspect, the ruthenium source housed in the external vessel contains an amount of a perruthenate material, such as sodium perruthenate (NaRuO₄) or potassium perruthenate (KRuO₄) which will react with the ozone, likely according to reaction (1) or (2), to form ruthenium tetroxide (RuO₄) a compound that is volatile at the reaction conditions.
2NaRuO₄+O₃+H₂O→RuO₄+2NaOH+Na₂O+O₂ (1)
2KRuO₄+O₃+H₂O→RuO₄+2KOH+K₂O +O₂ (2)
It should be noted that the list of materials shown here are not intended to be limiting, and thus any material that upon exposure to ozone or other oxidizing gases forms a ruthenium tetroxide containing gas may be used without varying from the basic scope of the invention. To form the various ruthenium source materials used in the external vessel, various conventional forming processes may be used.

The deposition chamber 600 generally contains a process gas delivery system 601 and a process chamber 603. FIG. 2 illustrates one embodiment of a process chamber 603 that may be adapted to deposit the ruthenium containing layers on the surface of a substrate. In one aspect, the process chamber 603 is adapted to deposit a adhesion layer on the surface of the substrate by use of a CVD, ALD, PECVD or PE-ALD process prior to depositing a ruthenium containing layer on the surface of the substrate 422 (FIG. 2). In another aspect, the process chamber 603 is adapted to primarily deposit the ruthenium containing layer and thus any prior or subsequent device fabrication steps are performed in other processing chambers. The use of a vacuum processing chamber during processing can be advantageous, since processing in a vacuum condition can reduce the amount of contamination that can be incorporated in the deposited film. Vacuum processing will also improve the diffusion transport process of the ruthenium tetroxide to the surface of the substrate and into the pores of the porous electrode (not shown) and tend to reduce the typical material build up limitations caused by convective type transport processes.

The process chamber 603 generally contains a processing enclosure 408, a showerhead 410, a temperature controlled substrate support 623, and the process gas delivery system 601 connected to the inlet line 426 of the process chamber 603. The processing enclosure 408 generally contains a sidewall 405, a ceiling 409 and a base 407 enclose the process chamber 603 and form a process area 421. A substrate support 623, which supports a substrate 422, mounts to the base 407 of the process chamber 603. In one embodiment of the deposition chamber 600, the substrate support 623 is heated and/or cooled by use of a heat exchanging device 620 and a temperature controller 621, to improve and control properties of the ruthenium layer deposited on the substrate 422 surface. In one aspect, the heat exchanging device 620 is a fluid heat exchanging device that contains embedded heat transfer lines 625 that are in communication with the temperature controller 621 which controls the heat exchanging fluid temperature. In another aspect, the heat exchanging device 620 is a resistive heater, in which case the embedded heat transfer lines 625 are resistive heating elements that are in communication with the temperature controller 621. In another aspect, the heat exchanging device 620 is a thermoelectric device that is adapted to heat and cool the substrate supporting surface 623A of the substrate support 623. A vacuum pump 435, such as a turbo-pump, cryo-turbo pump, roots-type blower, and/or rough pump, controls the pressure within the process chamber 603. The showerhead 410 consists of a gas distribution plenum 420 connected to the inlet line 426 and the process gas delivery system 601. The inlet line 426 and process gas delivery system 601 are in communication with the process region 427 over the substrate 422 through plurality of gas nozzle openings 430.

In one aspect of the invention it may be desirable to generate a plasma during the deposition process to improve the deposited ruthenium containing layer's properties. In this configuration, the showerhead 410, is made from a conductive material (e.g., anodized aluminum, etc.), which acts as a plasma controlling device by use of the attached to a first impedance match element 475 and a first RF power source 490. A bias RF generator 462 applies RF bias power to the substrate support 623 and substrate 422 through an impedance match element 464. A controller 480 is adapted to control the impedance match elements (i.e., 475 and 464), the RF power sources (i.e., 490 and 462) and all other aspects of the plasma process. The frequency of the power delivered by the RF power source may range between about 0.4 MHz to greater than 10 GHz. In one embodiment dynamic impedance matching is provided to the substrate support 623 and the showerhead 410 by frequency tuning and/or by forward power serving. While FIG. 2 illustrates a capacitively coupled plasma chamber, other embodiments of the invention may include inductively coupled plasma chambers or combination of inductively and capacitively coupled plasma chambers with out varying from the basic scope of the invention.

In one embodiment, the process chamber 603 contains a remote plasma source (RPS) (element 670 in FIG. 2) that is adapted to deliver various plasma generated species or radicals to the processing region 427 through an inlet line 671. An RPS that may be adapted for use with the deposition chamber 600 is an Astron® Type AX7651 reactive gas generator from MKS ASTeX® Products of Wilmington, Mass. The RPS is generally used to form, reactive components, such as hydrogen (H) or oxygen (O₂) radicals, which are introduced into the processing region 427. The RPS thus improves the reactivity of the excited gas species to enhance the reaction process. A typical RPS process may include using 1000 sccm of H₂ and 1000 sccm of argon and an RF power of 350 Watts and a frequency of about 13.56 MHz. In general, the use of plasma excitation to generate reducing species capable of converting RuO₂ to Ru will allow this reaction to proceed at lower temperatures until a ruthenium layer having a desired thickness is reached and then stopping the remote plasma generation to allow a RuO₂ film to form on the surface of the substrate 422. This process may be most useful when it is desired to deposit the RuO₂ selectively, generally below approximately 180° C.

In one embodiment of the deposition chamber 600, a process gas delivery system 601 is adapted to deliver a ruthenium containing gas, or vapor, to the processing region 427 so that a ruthenium containing layer can be formed on the substrate surface. The process gas delivery system 601 generally contains one or more gas sources 611A-E, an ozone generator 612, a processing vessel 630, a source vessel assembly 640 and an outlet line 660 attached to the inlet line 426 of the process chamber 603. The one or more gas sources 611A-E are generally sources of various carrier and/or purge gases that may be used during processing in the process chamber 603. The one or more gases delivered from the gas sources 611A-E may include, for example, nitrogen, argon, helium, hydrogen, or other similar gases.

Typically, the ozone generator 612 is a device which converts an oxygen containing gas from an gas source (not shown) attached to the ozone generator 612 into a gas containing between about 4 wt. % and about 100 wt. % of ozone (O₃), with the remainder typically being oxygen. Preferably, the concentration of ozone is between about 6 wt. % and about 100 wt. %. It should be noted that forming ozone in concentrations greater than about 15% will generally require a purification process that may require a process of adsorbing ozone on a cold surface in a processing vessel and then purging the vessel using an inert gas to remove the contaminants. However, the ozone concentration may be increased or decreased based upon the amount of ozone desired and the type of ozone generating equipment used. A typical ozone generator that may be adapted for use with the deposition chamber 600 are the Semozon® and Liquozon® Ozone generators that can be purchased from MKS ASTeX® Products of Wilmington, Mass. The gas source 611A may be adapted to purge or as a carrier gas to deliver the ozone generated in the ozone generator 612 to the input port 635 of the processing vessel 630.

In one embodiment of the process gas delivery system 601, the processing vessel 630 contains a vessel 631, a temperature controlling device 634A, an input port 635 and an output port 636. The vessel 631 is generally an enclosed region made of or coated with glass, ceramic or other inert material that will not react with the processing gas formed in the vessel 631. In one aspect, the vessel 631 contains a volume of a ruthenium source (e.g., ruthenium metal, sodium perruthenate; see reference numeral “A”), preferably in a porous-solid, powder, or pellet form, to promote the formation of ruthenium tetroxide when the ozone gas is delivered to the vessel 631. The temperature controlling device 634A generally contains a temperature controller 634B and a heat exchanging device 634C, which are adapted to control the temperature of the vessel 631 at a desired processing temperature during the ruthenium tetroxide generation process. In one aspect, the heat exchanging device 634C is a temperature controlled fluid heat exchanging device, a resistive heating device and/or a thermoelectric device that is adapted to heat and/or cool the vessel 631 during different phases of the process.

In one embodiment, a remote plasma source 673 is connected to the processing vessel 630 via the RPS inlet line 673A so that in different phases of the ruthenium tetroxide formation process the ruthenium source can be regenerated by injecting hydrogen (H) radicals into the vessel 631 to reduce any formed oxides on the surface of the ruthenium source. Regeneration may be necessary when an undesirable layer of RuO₂ is formed on a significant portion of the exposed ruthenium source contained in the vessel 631. In one embodiment, the regeneration process is performed when by introducing a hydrogen containing gas to the ruthenium source that has been heated to an elevated temperature in an effort to reduce the formed oxides.

In another embodiment, ruthenium tetroxide is formed using an aqueous hypochlorite solution. The first step of the ruthenium tetroxide formation process starts by first dissolving a ruthenium powder in an aqueous solution in a first vessel that contains sodium hypochlorite heated to 60° C. In one aspect, the process solution may be formed by dissolving ruthenium metal in a solution of excess sodium hypochlorite (NaOCl) followed by titration with sulfuric acid to a pH value near 7 to liberate ruthenium tetroxide. One will note that hypochlorite materials, such as potassium or calcium hypochlorite, may also be used in place of the sodium hypochlorite. The ruthenium tetroxide is likely formed according to reaction (3).
Ru(metal)+4NaOCl→RuO₄+4NaCl (3)
In one example, a process solution was formed by mixing 50 ml of a sodium hypochlorite (e.g., 10% NaOCI solution) with 1 gram of finely powdered ruthenium metal and stirring until dissolution is essentially complete. A sufficient amount of 10% solution of H₂SO₄ in water was then added to achieve a pH of about 7. In general, any acid that is non-oxidizable and non-volatile can be used in place of the sulfuric acid, such as phosphoric acid (H₃PO₄). Another example of a method of forming ruthenium tetraoxide using hypochlorite is further described in the U.S. patent application Ser. No. 11/228,425[APPM 9906], filed Sep. 15, 2005, which is herein incorporated by reference in its entirety.

Referring to FIG. 2, the source vessel assembly 640 generally contains a source vessel 641, a temperature controller 642, an inlet port 645 and an outlet port 646. The source vessel 641 is adapted to collect and retain the ruthenium tetroxide generated in the processing vessel 630. The source vessel 641 is generally lined, coated or made from a glass, ceramic, plastic (e.g., Teflon, polyethylene, etc.), or other material that will not react with the ruthenium tetroxide and has desirable thermal shock and mechanical properties. When in use the temperature controller 642 cools the source vessel 641 to a temperature less than 20° C. to condense the ruthenium tetroxide gas on to the walls of the source vessel. The temperature controller 642 generally contains a temperature controller device 643 and a heat exchanging device 644, which are adapted to control the temperature of the source vessel 641 at a desired processing temperature. In one aspect, the heat exchanging device 644 is a temperature controlled fluid heat exchanging device, a resistive heating device and/or a thermoelectric device that is adapted to heat and cool the source vessel 641.

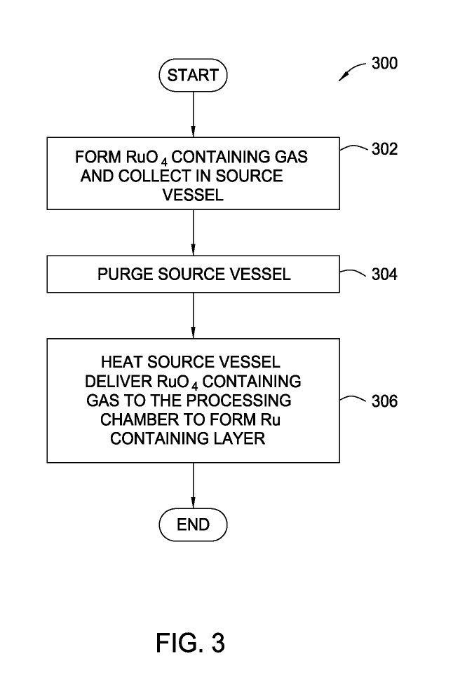

FIG. 3 depicts process 300 according to one embodiment described herein for forming a ruthenium containing layer on a surface of a substrate. Process 300 includes process steps 302-306, wherein a ruthenium containing layer is directly deposited on surface of a substrate. The first process step 302 of process 300 includes step of forming a ruthenium tetroxide gas and collecting the generated gas in the source vessel 641. In process step 302, ozone generated in the ozone generator 612 is delivered to the ruthenium source contained in the vessel 631 to form a flow of a ruthenium tetroxide containing gas, which is collected in the vessel 641. Therefore, during process step 302 an ozone containing gas flows across the ruthenium source which causes ruthenium tetroxide to be formed and swept away by the flowing gas. During this process the gas flow path is from the ozone generator 612, in the input port 635, across the ruthenium source (reference numeral “A” in FIG. 2), through the outlet port 636 in the vessel 631 through the process line 648 and into the closed source vessel 641. In one embodiment, it may be desirable to evacuate the source vessel 641 using a conventional vacuum pump 652 (e.g., conventional rough pump, vacuum ejector), prior to introducing the ruthenium tetroxide containing gas. In one aspect, the gas source 611A is used to form an ozone containing gas that contains pure oxygen and ozone or an inert gas diluted oxygen containing gas and ozone. In one aspect of process step 302, the ruthenium source (reference numeral “A”) contained in the vessel 631 is maintained at a temperature between about 0° C. and about 100° C., and more preferably between about 20° C. and about 60° C. to enhance the ruthenium tetroxide formation process in the vessel 631. While a lower ruthenium tetroxide generation temperature is generally desirable, it is believed that the required temperature to form a ruthenium tetroxide gas is somewhat dependent on the amount of moisture contained in the vessel 631 during processing. During process step 302, the source vessel 641 is maintained at a temperature below about 25° C. at pressures that allow the generated ruthenium tetroxide to condensed, or crystallized (or solidified), on the walls of the source vessel 641. For example, the source vessel 641 is maintained at a pressure of about 5 Torr and a temperature between about −20 and about 25° C. By cooling the ruthenium tetroxide and causing it to condense or solidify on the walls of the source vessel 641 the unwanted oxygen (O₂) and ozone (O₃) containing components in the ruthenium tetroxide containing gas can be separated and removed in the second process step 304. In one aspect, it may be desirable to inject an amount of water, or a water containing gas, into the vessel 631 to promote the ruthenium tetroxide generation process. The injection of water may be important to improve the dissociation of the ruthenium tetroxide from the ruthenium source, for example, when ruthenium source contains sodium perruthenate or potassium perruthenate. In one aspect, it may be desirable to remove the excess water by a conventional physical separation (e.g., molecular sieve) process after the dissociation process has been performed.

The second process step 304, or purging step, is designed to remove the unwanted oxygen (O₂) and unreacted ozone (O₃) components from the ruthenium tetroxide containing gas. Referring to FIGS. 2 and 3, in one embodiment the process step 304 is completed while the walls of the source vessel 641 are maintained at a temperature of 25° C. or below, by closing the ozone isolation valve 612A and flowing one or more purge gasses from the one or more of the gas sources 611B-C through the processing vessel 630, into the process line 648, through the source vessel 641 and then through the exhaust line 651 to the exhaust system 650. The amount of un-solidified or un-condensed ruthenium tetroxide that is wasted during the completion of process step 304, can be minimized by adding a wait step of a desired length between the process step 302 and process step 304 to allow the ruthenium tetroxide time to condense or solidify. The amount of un-solidified or un-condensed ruthenium tetroxide that is wasted can be further reduced also by lowering the source vessel wall temperature to increase the rate of solidification, and/or increasing the surface area of the source vessel to increase the interaction of the walls and the ruthenium tetroxide containing gas. The purge gases delivered from the one or more gas sources 611B-C can be, for example, nitrogen, argon, helium, or other dry and clean process gas. Since the unwanted oxygen (O₂) and unreacted ozone (O₃) components can cause unwanted oxidation of exposed surfaces on the substrate the process of removing these components can be critical to the success of the ruthenium deposition process. In one embodiment, the process step 304 is completed until the concentration of oxygen (O₂) and/or unreacted ozone (O₃) is below about 100 parts per million (ppm). In one aspect, it may be desirable to heat the vessel 631 to a temperature between about 20° C. and 25° C. during the process step 304 to assure that all of the formed ruthenium tetroxide has been removed from the processing vessel 630.

In one aspect, the purging process (step 304) is completed by evacuating the source vessel 641 using a vacuum pump 652 to remove the contaminants. To prevent an appreciable amount of ruthenium tetroxide being removed from the source vessel assembly 640 during this step the temperature and pressure of the vessel may be controlled to minimize the loss due to vaporization. For example, it may be desirable to pump the source vessel assembly 640 to a pressure of about 5 Torr while it is maintained at a temperature below about 0° C.

In one embodiment, the third process step 306, or deliver the ruthenium tetroxide to the process chamber 603 step, is completed after the source vessel 641 has been purged and valve 637A is closed to isolate the source vessel 641 from the processing vessel 630. The process step 306 starts when the source vessel 641 is heated to a temperature to cause the condensed or solidified ruthenium tetroxide to form a ruthenium tetroxide gas, at which time the one or more of the gas sources 611 (e.g., items 611D and/or 611E), the gas sources associated isolation valve (e.g., items 638 and/or 639) and process chamber isolation valve 661 are opened which causes a ruthenium tetroxide containing gas to flow into the inlet line 426, through the showerhead 410, into an processing region 427 and across the temperature controlled substrate 422 so that a ruthenium containing layer can be formed on the surface of the substrate 23. In one embodiment, the source vessel 641 is heated to a temperature between about 0° C. and about 50° C. to cause the condensed or solidified ruthenium tetroxide to form a ruthenium tetroxide gas. It should be noted that even at the low temperatures, for example about 5° C., an equilibrium partial pressure of ruthenium tetroxide gas will exist in the source vessel 641. Therefore, in one aspect, by knowing the mass of ruthenium tetroxide contained in the vessel, by knowing the volume and temperature of the source vessel 641, a repeatable mass can be delivered to the process chamber 603. In another aspect, a continuous flow of a ruthenium tetroxide containing gas can be formed and delivered to the process chamber 603, by knowing the sublimation or vaporization rate of the ruthenium tetroxide at a given temperature for a given sized source vessel 641 and flowing a carrier gas at a desired rate through the source vessel 641 to form a gas having a desired concentration of ruthenium tetroxide.

In order to deposit a ruthenium containing layer non-selectively on a surface of the substrate, it is believed that at temperatures greater then 180° C. ruthenium tetroxide (RuO₄) is will undergo a spontaneous decomposition to thermodynamically stable ruthenium dioxide (RuO₂), and at slightly higher temperatures in the presence of hydrogen (H₂) the deposition proceeds directly to forming a metallic ruthenium layer. For forming an active surface in an electrochemical capacitor it is desirable to form a layer of RuO₂ on the surface of the porous electrode 120, charge collector plate 150, or the combination of the both porous electrode 120 and charge collector plate 150. The balanced equation for the two different reactions are shown in equations (4) and (5).
RuO₄RuO₂→O₂ (4)
RuO₄+4H₂→Ru(metal)+4H₂O (5)
Therefore, in one embodiment of the invention, during the process step 306 the substrate surface is maintained, by use of the temperature controlled substrate support 623, at a temperature above about 180° C., and more preferably at a temperature between of about 180° C. and about 450° C. To form a metallic ruthenium layer the temperature may be between about 300° C. and about 400° C. Typically the processing chamber pressure is maintained at a pressure below about 10 Torr, and preferably between about 500 milliTorr (mT) and about 5 Torr. By controlling the temperature of the surface of the substrate the selectivity of the deposited ruthenium containing layer and crystal structure of the deposited ruthenium containing layer can be adjusted and controlled as desired. It is believed that a crystalline ruthenium containing layer will be formed at temperatures above 350° C.

In one aspect of the process step 306, a the ruthenium tetroxide containing gas is formed when a nitrogen containing gas is delivered from the gas source 611D and a hydrogen (H₂) containing gas (e.g., hydrogen (H₂), hydrazine (N₂H₄)) is delivered from the gas source 611E through the source vessel assembly 640 containing an amount of ruthenium tetroxide and then through the process chamber 603. For example, 100 sccm of nitrogen and 100 sccm of H₂ gas is delivered to the process chamber 603 which is maintained at a pressure between about 0.1 and about 10 Torr, and more preferably about 2 Torr. The desired flow rate of the gasses delivered from the gas sources 611 (e.g., items 611D-E) is dependent upon the desired concentration of the ruthenium tetroxide in the ruthenium tetroxide containing gas and the vaporization rate of the ruthenium tetroxide from the walls of the source vessel 641.

In one embodiment of process step 306, the amount of ruthenium tetroxide gas generated and dispensed in the process chamber 603 is monitored and controlled to assure that the process is repeatable, complete saturation of the process chamber components is achieved and a desired thickness of the ruthenium containing film has been deposited. In one aspect, the mass of the ruthenium tetroxide delivered to the process chamber is monitored by measuring the change in weight of the source vessel 641 as a function of time, by use of a conventional electronic scale, load cell, or other weight measurement device.

In one embodiment, the gas delivery system 601 is adapted to deliver a single dose, or mass of ruthenium tetroxide, to the process chamber 603 and the substrate to form a ruthenium containing layer on the surface of the substrate. In another embodiment, multiple sequential doses of ruthenium tetroxide are delivered to the process chamber 603 to form a multilayer ruthenium containing film. To perform the multiple sequential doses at least one of the process steps 302 through 306, are repeated multiple times to form the multilayer ruthenium containing film. In another embodiment, the surface area of the source vessel 641 and the length of the process step 302 are both sized to allow a continuous flow of a desired concentration of a ruthenium tetroxide containing gas across the surface of the substrate during the ruthenium containing layer deposition process. The gas flow distribution across the surface of the substrates can be important to the formation of uniform layers upon substrates processed in the processing chamber, especially for processes that are dominated by mass transport limited reactions (CVD type reactions) and for ALD type processes where rapid surface saturation is required for reaction rate limited deposition. Therefore, the use of a uniform gas flow across the substrate surface by use of a showerhead 410 may be important to assure uniform process results across the surface of the substrate.

In one aspect of the invention, the process of delivering a mass of ruthenium tetroxide into the process chamber 603 has advantages over conventional ALD or CVD type processes, because the organic material found in the ALD or CVD precursor(s) are not present in the ruthenium containing gas and thus will not be incorporated into the growing ruthenium containing layer. The incorporation of the organic materials in the growing ruthenium film can have large affect on the electrical resistance, catalytic properties, and the adhesion of the deposited film. Also, since the size of the ruthenium tetraoxide molecule is much smaller than the traditional ruthenium containing precursors the ruthenium containing layer deposition rate per ALD type cycle using ruthenium tetroxide will be increased over conventional precursors, due to the improved ruthenium coverage per ALD cycle. It is believed that this is especially true in cases where a ruthenium dioxide or metallic ruthenium layer is to be deposited on the porous electrode 120, charge collector plate 150 or both of them at the same time (discussed above).

In one aspect, the inert gas source 674 and/or the dosing vessel 662 are used to “dose,” or “pulse,” the ruthenium tetroxide containing gas into the processing region 427 so that the gas can saturate the surface of the porous electrode 120 and/or charge collector plate 150 (e.g., an ALD type process). The “dose,” or “dosing process,” may be performed by opening and closing the various isolation valves for a desired period of time so that a desired amount of the ruthenium containing gas can be injected into the process chamber 603. In one aspect, no inert gas is delivered to the dosing vessel 662, from the gas source 674, during the dosing process. The use of a dosing type process may be useful to allow and assure complete coverage of the porous electrode 120 surface. The dosing type process can allow complete saturation of the exposed porous electrode surface before multiple layers of Ru are deposited on the porous electrode surface which can restrict the flow of ruthenium tetroxide to the areas of the porous electrode accessible through the pores.

In yet another one embodiment of the method of generating a ruthenium tetroxide (e.g., step 302), a ruthenium tetroxide containing gas is formed using ruthenium dioxide hydrate (RuO₂.H₂O) that is combined with potassium periodate (KIO₄) and DI water to form ruthenium tetroxide at room temperature. In one example, about 0.3 g of RuO₂ was added to Pyrex® glass bubbler that contains 2.0 g of KIO₄ and 50 ml of DI water at room temperature to form a ruthenium tetroxide containing gas that was entrained in a flow of a gas (e.g., air) that was bubbled through the mixture. In some cases it may be desirable to separate any entrained water vapor, or other undesirable components, in the ruthenium containing gas by use of a conventional physical separation (e.g., molecular sieves), cold trap or other conventional schemes.

It should be noted that one or more of the processes described above can be used to deposit a ruthenium containing layer on the surfaces of the substrate by disposing the substrate in a processing region of a processing chamber and then exposing substrate to the ruthenium tetroxide so that the ruthenium tetroxide envelops all of the surfaces of the substrate. Conventional RF inductive heating may be used to control the temperature of the substrates in the processing region of the processing chamber.

Ruthenium Treatment Using Hypophosphorous Acid

In one embodiment, the porous electrode 120, charge collector plate 150, or the combination of the both porous electrode 120 and charge collector plate 150 are coated with a layer containing ruthenium dioxide (RuO₂) and/or ruthenium (Ru), or a region of Ru and/or RuO₂ adherent particles, that are deposited on the desired regions of the porous electrode 120, the charge collector plate 150, or the combination of the both porous electrode 120 and charge collector plate 150 by applying hypophosphorous acid (H₃PO₂) to the surface(s) of the component and then exposing the treated surface with ruthenium tetroxide (RuO₄). Hypophosphorous acid is commercially available as an aqueous solution which can selectively applied to various desired surfaces. In one embodiment, it is desirable to deliver an amount of a solution that contains a desired amount of hypophosphorous acid to control the amount of ruthenium dioxide that is deposited. The reaction of hypophosphorous acid with ruthenium tetroxide will generally follow the equation shown in equation (6).
RuO₄+H₃PO₂→RuO₂+H₃PO₄ (6)
The formation of the RuO₂ layer may be performed at room temperature, since hypophosphorous acid is such a strong reducing agent for ruthenium tetroxide. If desired, the RuO₂ formed layer can then be further reduced to form metallic ruthenium by exposing the RuO₂ layer to a hydrogen gas, or for that matter excess H₃PO₂ or N₂H₂ at elevated temperature.
Aqueous Deposition Process

In one embodiment, a ruthenium dioxide containing layer is formed by use of a aqueous solution that contains dissolved ruthenium tetroxide and an acid that heated to a desired temperature (e.g., 50-80° C.). Typically, a desirable acid is a mineral acid, such as sulfuric (H₂SO₄), or phosphoric (H₃PO₄). The reaction using an acidic solution will generally follow the equation shown in equation (7).
RuO₄(aq)→RuO₂(S)+O₂ (7)
The formation of the RuO₂ layer may be formed on the surface of the porous electrode 120 and/or charge collector plates 150 at moderate solution temperatures. If desired, the RuO₂ formed layer can then be further reduced to form metallic ruthenium by exposing the RuO₂ layer to a reducing agent, which is discussed above.
Depositon Using a Ruthenium Precursor

In one embodiment, it may be desirable to deposit a ruthenium containing layer over the surface of the porous electrode 120, charge collector plate 150 or both of them by exposing the substrate surface to a conventional ruthenium precursor material commonly used to deposit ruthenium containing layers on semiconductor wafers. The ruthenium layer may be deposited using a cyclical deposition process or conventional CVD type process. The cyclical deposition process comprises alternately adsorbing a ruthenium-containing precursor and a reducing gas on a substrate structure. During processing the ruthenium-containing precursor and a reducing gas (e.g., hydrogen (H₂), ammonia (NH₃)) undergo a reaction to form the ruthenium layer on the substrate. In general, for ruthenium layer deposition, the substrate should be maintained at a temperature less than about 500° C., preferably in a range from about 200° C. to about 400° C., for example, about 300° C. The process chamber pressure during the deposition process may be is maintained in a range from about 0.1 Torr to about 80 Torr. In general some useful ruthenium precursors include, but are not limited to ruthenocene compounds, such as bis(ethylcyclopentadienyl)ruthenium, bis(cyclopentadienyl)ruthenium bis(pentamethylcyclopentadienyl)ruthenium, methylcyclopentadienly pyrrolyl ruthenium, and dicarbonylBis(N,N′-Di-Tert-Butylacetamindinato)Ruthenium (II).

Catalyst Deposition and/or Protective Coating Process

In one embodiment, a ruthenium containing layer is deposited on all the exposed surfaces within porous electrode 120, charge collector plate 150 and membrane 110 in an assembled electrochemical capacitor (shown in FIG. 1). The exposed surfaces generally include the porous electrode 120 surfaces and charge collector 150 surfaces. In one aspect, the deposition of ruthenium containing layer is meant to improve the catalytic reactions occurring at the surfaces of the porous electrode 120 and/or charge collector plate 150. The deposited ruthenium layer can thus be used to 1) fix damaged or discontinuous coatings, 2) further prevent chemical attack of assembled electrochemical capacitor components, and 3) also help improve the catalytic efficiency of the one or more catalytic materials disposed on an electrode section of the electrochemical capacitor.

To deposit ruthenium on all the exposed surfaces within porous regions of the porous electrode 120, in one embodiment, the process step 306 is used to deliver ruthenium tetroxide to the exposed components through an electrolyte inlet to the active region 140. In this process an amount of ruthenium tetroxide gas is generated and dispensed into one, or both, of the porous region maintained at a desired temperature until a desired thickness of the ruthenium containing film (e.g., metallic ruthenium or ruthenium dioxide) has been deposited. By heating one or more of the electrochemical capacitor components to a desired temperature a ruthenium containing layer having desirable properties can be selectively, or non-selectively, deposited of one or more desired surfaces.

Ruthenium Dioxide Layer Formation on Carbon Containing Elements

It is believed that due to the ability to selectively, or non-selectively, deposit a ruthenium layer at low deposition temperatures (e.g., <200° C.) using a ruthenium tetroxide containing gas, uniquely provides a method that can be used to deposit a ruthenium dioxide layer and/or ruthenium metal on the surfaces contained in the porous regions of the porous electrode to form a catalytic layer and/or make the surfaces of the porous electrode 120 and/or charge collector plate 150 more conductive. In one aspect, a selective deposition process at temperatures <100° C. is used to form a ruthenium dioxide (RuO₂) layer on desirable surfaces of the electrochemical capacitor surfaces. In contrast to higher temperature CVD type deposition processes, low temperature deposition schemes can beneficially result in a porous coating on the porous carbon fiber structure commonly used at the electrode surfaces of the porous electrode 120.

Methods of forming a high surface area carbon porous electrodes are well known in the art. Therefore, a cost effective porous electrode 120 and charge collector plate 150 structure can be formed that has a ruthenium containing layer over a high surface area carbon containing base material. Carbon containing porous electrodes 120 are commonly used to form electrochemical capacitors due to the number of cost effective method of forming a high surface area electrically conductive porous structures. Typical, the carbon containing porous electrodes are made from materials, such as carbon nanotubes, carbon aerogels, graphite cloth, graphite powders, activated carbon, most plastics or carbon black.

To form a porous electrode that has a ruthenium containing surface the ruthenium tetroxide deposition process, discussed above can be used. The interaction of the ruthenium tetroxide and the carbon containing base material can be completed selectively at low temperatures. The reaction occurring during the low temperature process causes the some of the carbon at the surface of the porous electrode 120 to be replaced with a RuO₂ layer (e.g., RuO₄+C→RuO₂+CO₂). If desired a metallic ruthenium layer can be deposited on the carbon at the surface of the porous electrode at temperatures >250° C. in the presence of a reducing gas (e.g., RuO₄+C+2H₂→Ru+CO₂+2H₂O) and then a ruthenium dioxide layer can be deposited thereon. A thicker ruthenium film will increase the conductivity of the porous electrode 120 and charge collector 150 plates, which improve the resistance-capacitance (RC) characteristics of the device. Therefore, a cost effective high surface area porous electrode 120 structure can be formed.

Enhanced Metal Oxide Coating Deposition Apparatus and Method

In one embodiment, a plurality of layers of ruthenium dioxide (RuO₂) and a metal oxide, such as titanium dioxide (TiO₂), tin oxide (SnOₓ; x=1 or 2) or zinc oxide (ZnOₓ; x=1 or 2), is deposited over the surface of the porous electrode 120 and/or charge collector plates 150 to enhance their corrosion resistance to the electrolyte material, improve the electrode's conductivity and capacitance of the electrochemical capacitor unit 100.

Referring to FIG. 2, in one embodiment a gas source assembly 250 containing a plurality of gas sources 251, 252 are adapted to deliver a deposition gas to the inlet line 426, processing region 427 and substrate 422. Each of the gas sources 251, 252 may also contain a number of valves (not shown) that are connected to the controller 480 so that a ruthenium containing gas can be delivered from the process gas delivery system 601 (FIG. 2), and/or a deposition gas can be delivered from the gas sources 251, 252.

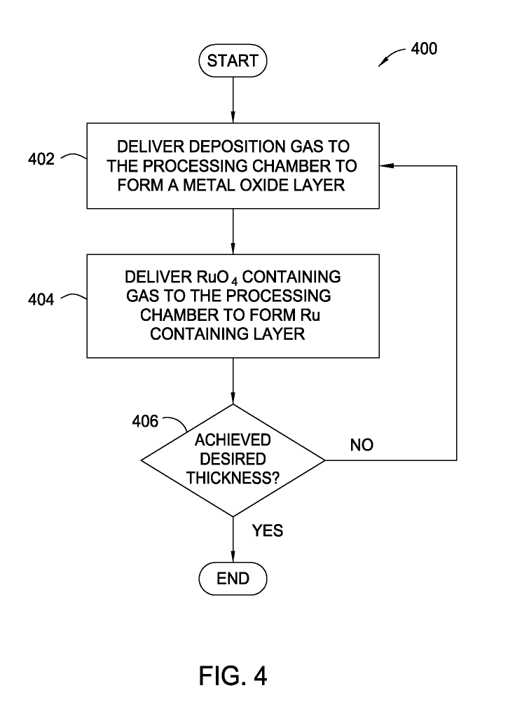

FIG. 4 depicts a process sequence 400 according to one embodiment described herein for forming a coating contain multiple layers of a metal oxide and a ruthenium containing layer on a surface of a substrate, such as the porous electrode 120 and/or the charge collector plates 150. Process sequence 400 includes steps 402-406, wherein the metal oxide and ruthenium containing layers are directly deposited on surface of a substrate. In step 402, a metal oxide layer is deposited on the surface of the substrate by delivering a deposition gas to the surface of the substrate from a gas source, such as gas source 251 shown in FIG. 2. In one aspect, the substrate is positioned on a temperature controlled substrate support 623 which is maintained at a temperature between about 20° C. and about 100° C. It should be noted that while the process sequence 400 described herein begins with the deposition of a metal oxide layer, other than a ruthenium containing layer, on the surface of the substrate this configuration is not intended to limiting as to the scope of the invention described herein.

In one embodiment, the metal oxide layer contains titanium dioxide (TiO₂), tin oxide (SnOₓ; x=1-2 or zinc oxide (ZnO)) material which is deposited using a deposition gas delivered from a gas source assembly 250. In general the metal oxide and/or the ruthenium dioxide layer may be deposited or formed on the porous electrode 120 and charge collector plates 150 by use of a chemical vapor deposition (CVD), atomic layer deposition (ALD) process, electrochemical plating or other conventional deposition technique. In one example, the metal oxide layer is a titanium dioxide layer deposited on the surface of the porous electrode 120 and/or the charge collector plates 150 maintained at a temperature less than about 100° C. using a deposition gas containing about 5% to about 95% titanium isopropoxide (Ti[OCH(CH₃)₂]₄) and the balance being an inert carrier gas, such as argon or nitrogen. In this example the titanium dioxide layer may be between about 3 angstroms (Å) and about 100 Å thick. In another example the deposition gas is a conventional titanium precursor, such as titanium tetrachloride (TiCl₄), TDEAT (tetrakis diethylaminotitanium) and TDMAT (tetrakis dimethylaminotitanium). The deposited layer may be subsequently oxidized to form a metal oxide layer. In one example, the titanium layer is subsequently oxidized using a gas that contains a small amount of water vapor (ppm range) which is delivered to the surface of the substrate, which is maintained at an elevated temperature, such as about 100° C., to oxidize the deposited metal layer.

In step 404, a ruthenium containing layer is directly deposited on surface of the substrate using a ruthenium tetroxide containing gas delivered from a ruthenium tetroxide source, such as a process gas delivery system 601 discussed above in FIG. 2. The step 404 may contain all of the steps described in process 300 depicted in FIG. 3, which is used to deposit a ruthenium containing layer on the surface of the substrate. In one example, a ruthenium dioxide layer is deposited on the surface of the porous electrode 120 and/or the charge collector plates 150 that are maintained at a temperature less than about 100° C. using a deposition gas containing about 0.1% to about 95% ruthenium tetroxide and the balance being an inert carrier gas, such as argon or nitrogen. In this example the ruthenium dioxide layer may be between about 3 angstroms (Å) and about 100 Å thick.

Finally, in step 406, based on a desired number of cycles in which steps 402 and 404 are repeatedly performed, or a desired conductivity of the coating containing the metal oxide and ruthenium dioxide layers has been achieved, the process sequence 400 will be ended. In one example, only a single layer of a metal oxide and single layer of ruthenium dioxide are deposited on the surface of the substrate. In another example multiple metal oxide and ruthenium dioxide layers are deposited until the total coating thickness is between about 50 Å and about 250 Å.

In one embodiment of the process sequence 400, the metal oxide layer is deposited during step 402 is formed using an electrochemical process. In one example, a titanium layer is formed on the substrate using an electrolyte solution that contains titanium chloride (TiCl₃) using conventional electrochemical plating techniques. The formed titanium layer can then be oxidized by heating the substrate and exposing it to an oxidizing gas (e.g., 50-250° C.). In another example, a tin layer is formed on the substrate using an electrolyte solution that contains stannous chloride (SnCl₂) using conventional electrochemical plating techniques. The formed tin layer can then be oxidized by heating the substrate and exposing it to an oxidizing gas. In yet another embodiment, a zinc layer is formed on the substrate using an electrolyte solution that contains zinc chloride (ZnCl₂) or by CVD using diethylzinc (Zn(C₂H₅)₂) as a precursor. The formed zinc layer can then be oxidized by heating the substrate and exposing it to an oxidizing gas.

In another embodiment, a metal oxide (e.g., TiO₂, SnO₂, ZnO₂) and ruthenium dioxide are co-deposited to form a layer that contains a desired percentage of the metal oxide and ruthenium dioxide in the deposited layer. In one aspect, the formed layer may contain about 20% to about 80% of titanium dioxide and the balance being ruthenium dioxide.

It has been found that the formation of layered structure and/or co-deposited layer of a metal oxide, such as titanium dioxide, and ruthenium dioxide can increase the adhesion strength and corrosion resistance of an electrode structure. The methods described herein provide a method of depositing a metal oxide and a ruthenium containing layer at low temperatures, such as <100° C., thus avoiding the degradation of capacitance commonly found in the prior art using powders that require a high temperature sintering and/or annealing processes.

Also, it is believed that the embodiments described herein have an advantage over conventional electrochemical capacitor formed by sintering and annealing particles containing ruthenium dioxide and titanium dioxide, since the deposited films will not contain organic components that are commonly used to bind the metal particles prior to performing the annealing and/or sintering process. It is also believed that the embodiments described herein have an advantage over conventional electrochemical capacitor formed by conventional CVD or ALD techniques, since the deposited films need not contain organic components commonly found in conventional precursors used to deposit the metal oxide or ruthenium dioxide layers. Organic materials that are incorporated into the deposited films will affect the conductivity, density, corrosion resistance and adhesive properties of the metal oxide or ruthenium dioxide layers deposited over the surface of the porous electrode 120 and/or charge collector plates 150.

Moreover, it is believed that the formation a non-crystalline ruthenium dioxide layer using the low deposition temperature processes, which are discussed above, and the fact that crystallization and crystal growth can be prevented or minimized due to the removal of the need to heat the substrate to high processing temperatures to sinter ruthenium oxide particles to form an electrode and/or remove unwanted organic materials from the formed electrode will improve the specific capacitance of the formed device. Prior art references have noted that the specific capacitance of the formed device generally decreases as the degree of crystallinity of the formed ruthenium dioxide coating increases. This effect may be due to inability of the ruthenium oxides in the bulk of the crystal to participate as charge storage sites versus the ability of more exposed ruthenium dioxide sites to participate in the charge storage when using an amorphous structure.

While the foregoing is directed to embodiments of the present invention, other and further embodiments of the invention may be devised without departing from the basic scope thereof, and the scope thereof is determined by the claims that follow.

1. A method of forming an electrochemical capacitor, comprising:
providing a first substrate that has a surface that is adapted to form a portion of an electrode in an electrochemical capacitor; and
depositing a ruthenium dioxide coating on the surface of the first substrate, wherein the ruthenium dioxide coating is deposited using ruthenium tetroxide.

2. The method of claim 1, wherein the first substrate is maintained at a temperature between about 20° C. and about 180° C. when depositing a ruthenium dioxide layer.

3. The method of claim 1, wherein the ruthenium dioxide coating on the surface of the substrate is formed using a gas comprising ruthenium tetroxide.

4. The method of claim 1, further comprising:
providing a second substrate that has a surface that is adapted to form a portion of an electrode in the electrochemical capacitor;
depositing a ruthenium dioxide coating on the surface of the second substrate, wherein the ruthenium dioxide coating is deposited using ruthenium tetroxide; and
disposing a membrane and an electrolyte between the ruthenium dioxide coating on the first substrate and the ruthenium dioxide coating on the second substrate.

5. The method of claim 1, wherein the membrane comprises a material selected from a group consisting of polyethylene, glass, carbon, perfluoronated sulfonic acid polymer, sulphonated fluorocarbon polymer, and polybenzimidazole.

6. The method of claim 1, further comprising forming a layer on the surface of the first substrate before depositing the ruthenium dioxide coating, wherein the layer comprises oxides of ruthenium, and oxides of titanium, oxides of zinc, or oxides of tin.

7. The method of claim 6, wherein the layer is formed by sequentially exposing the surface to a ruthenium containing gas and a precursor, wherein the precursor comprises titanium, zinc, or tin.

8. A method of forming an electrochemical capacitor, comprising:
positioning a substrate that has a surface that is adapted to form a portion of a porous electrode in an electrochemical capacitor in a processing region of a processing chamber;
forming a gas comprising ruthenium tetroxide in a first vessel;
transferring an amount of the gas to the surface of the substrate to form a ruthenium containing layer thereon.

9. A method of claim 8, wherein the substrate is disposed on a substrate support that is maintained at a temperature between about 20° C. and about 180° C.

10. A method of claim 8, wherein forming a ruthenium tetroxide containing gas comprises:
forming an ozone containing gas; and
delivering the ozone containing gas to a surface of a ruthenium containing material positioned in the first vessel.

11. A method of claim 8, wherein the ruthenium containing material is a material selected from a group consisting of metallic ruthenium, sodium perruthenate or potassium perruthenate.

12. A method of forming an electrochemical capacitor, comprising:
positioning a substrate that has a surface that is adapted to form a portion of a porous electrode in an electrochemical capacitor in a processing region of a processing chamber;
forming a process gas comprising ruthenium tetroxide in a first vessel;
transferring at least a portion of the process gas from the first vessel to a second vessel;
removing unwanted contaminants contained in the second vessel; and
delivering an the ruthenium tetroxide from the second vessel to the substrate positioned on a substrate support in the processing region to form a ruthenium containing layer on a surface of the substrate.

13. The method of claim 12, wherein the step of removing unwanted contaminants further comprises:
receiving an amount of the process gas from the first vessel;
collecting a desired amount of ruthenium tetroxide from the process gas on a surface of the second vessel that is maintained at a first temperature; and
purging the second vessel with a purge gas to remove contaminants from the second vessel after collecting a desired amount of ruthenium tetroxide; and
vaporizing a desired amount of the ruthenium tetroxide found on the surface of the second vessel.

14. The method of claim 13, wherein the first temperature of the surface is between about −20° C. and about 25° C.

15. A method of claim 13, wherein the vaporizing step comprises:
heating the surface of the second vessel to a second temperature between about 0° C. and about 25° C.

16. A method of claim 12, wherein the processing region is adapted to process a substrate at a processing pressure between about 0.1 mtorr and about 50 Torr.

17. A method of forming an electrochemical capacitor, comprising:
providing a substrate that has a surface that is adapted to form a portion of a porous electrode in an electrochemical capacitor;
providing an aqueous solution that comprises a ruthenium metal, water and a hypochlorite containing material;
adding an amount of an acid to the aqueous solution;
separating the ruthenium tetroxide from the aqueous solution; and
delivering the ruthenium tetroxide to the substrate positioned on a substrate support in a processing chamber.

18. A method of claim 17, wherein the substrate support is maintained at a temperature between about 20° C. and about 180° C.

19. A method of claim 17, wherein the perruthenate material is selected from a group consisting of sodium perruthenate or potassium perruthenate.

20. A method of claim 17, wherein the solvent is selected from a group consisting of perfluorocarbons, hydroflurocarbons, or chlorofluorocarbons.
